(19) United States
(12) Patent Application Publication
(10) Pub. No.: US 2003/0097794 A1
(43) Pub. Date: May 29, 2003

(54) Double door drive unit with spring closing system

(75) Inventor: Daniel Brennwald, Neerach (CH)

Correspondence Address: BROWDY AND NEIMARK, P.L.L.C, 624 Ninth Street, N.W., Washington, DC, 20001, US

(73) Assignee: Landert-Motoren-AG, Bulach (CH)

(21) Appl. No.: 10/259,832

(22) Filed: Sep. 30, 2002

(30) Foreign Application Priority Data
Sep. 29, 2001 (DE) 101 48 293.0

(51) Int. Cl. E05F 11/00

(52) U.S. Cl. 49/336

(57) ABSTRACT

The present invention is concerned with a double door drive unit with spring closing system wherein the double door is opened by means of a drive unit and closed by spring force. It is characterized in that a toothed rack is guided axially movable on a rotating driven ball screw, said toothed rack operating against the load of a spring actuator, and that the toothed rack is in combing engagement with a pinion, which, in turn is connected to the driving linkage for the double door drive unit in such a way that it is integral in rotation with said driving linkage. This results in a very space-saving design for the device.

The object of the present invention is a double door drive unit with a spring closing system according to the preamble of claim 1.

A double door drive unit is usually composed of an electric motor with multiple gear steps leading to the driven shaft. These gear reducer units are belts, sets of gearwheels, or a combination thereof. Also customary are hydraulic gear units in which a toothed piston drives the driven pinion. The transmission of the torque from the driven shaft to the door is usually effected by means of a rod assembly. The door is opened by the motor and closed by means of a spring. However, devices are also known that are built without a spring and wherein the closing movement is also motor driven.

While the devices without spring closing system are very slim-lined in their design, they are useless without electricity, whereas the devices with a spring closing system assume the function of a door closer. However, due to their principle-inherent characteristics, the devices with a spring closing system have a wide-bodied design. (Space for gear steps and the spring. Not all types of gears work because the spring must be able to turn back the gear together with the motor.) Hydraulic units are expensive and loud.

Double door drive units of this type are commonly installed in the lintel area above the door or on the door leaf. It is of great importance in this context that the housing of the double door drive unit has the lowest possible height in the frontal view (in the view onto the door). This ensures that the double door drive unit can be installed also in narrow spaces. Additionally, the optical appearance is favorable when a very narrow drive unit can be installed in the door lintel or on the door leaf.

The invention is, therefore, based on the object of improving a double door drive unit with spring closing system of the above type in such a way that the height of the drive unit that is visible on the front of the door is kept as small as possible.

To meet this object, the invention is characterized in that a toothed rack is guided axially moveable on a rotating driven ball screw in such a way that the toothed rack works against the load of a spring actuator and that the toothed rack is in combing engagement with a pinion which, in turn, is connected to the driving linkage for the double door drive in such a way that it is integral in rotation with said driving linkage.

According to the existing technical teachings, this creates the significant advantage that it has now become possible for the first time to attain, in a very small space, a very large step-down ratio from the motor speed to a corresponding step-reduced speed for the drive unit of the double door. In accordance with the invention, step-down ratios are attained in the range of 70:1 to 100:1. These numbers are provided only as an example to document that a very high step-down ratio is attained in the smallest possible space. These numbers are, of course, not to be construed as limiting for the invention. Step-down ratios of 150:1 or the like can also be attained.

It is a significant feature of the invention in any case that a freely moving ball screw is used that is low-friction due to its design.

It is characteristic for this type of design that, in order to reduce the friction, ball tracks, which are filled with appropriate balls are disposed between the threaded spindle and the threaded nut. In this manner it becomes possible to operate the ball screw with a particularly low fiction.

Provision is now made according to the invention for the threaded nut to be connected to a toothed rack so that the entire assembly of threaded nut and toothed rack is supported axially moveable—but not rotating—on the threaded spindle.

If now—as provided under the invention—the threaded nut effects the tightening of the spring actuator, this creates the advantage that when the threaded nut is moved in one direction, the spring actuator is accordingly placed under tension. If the motor should fail at this time, the force of the spring will be sufficient without power to the motor to move the threaded nut back into its original starting position with a relaxed spring actuator.

This ensures that the double door drive unit automatically transitions into its closed position, even when there is a power outage. Even during a power outage it is still possible to open the door by manually pushing on the double door, as the toothed rack is then also moved by means of the torque on the pinion and, due to the low friction of the spindle nut on the ball screw, this ball screw then turns automatically. This, in turn, recharges the spring actuator, even when the drive unit is without electric power.

It has now been found that the use of a low-friction ball screw is optimally suited to attain a minimal height of the drive unit on the whole. This is due to the fact that the ball screw has a very high step-down-ratio of, e.g., 30:1.

An additional advantage of using the ball screw is its low-friction movement, which makes it possible for a rotating drive of the ball screw to result also from forces placed on the toothed rack from the driven side.

According to an additional embodiment of the invention, the length of the drive unit also is shortened in such a way that the drive unit motor is not connected in an axial extension directly to the ball screw, but the drive unit motor is disposed offset above or next to the ball screw and drives the same by means of a step-down gear.

In addition to the direct flange-mounting of the electric motor (which is also claimed by this invention), it is preferred that the ball screw is driven by means of a corresponding gear. The gear in question is a simple, step-down belt drive unit, and a step-down ratio of 3:1 may be used, for example.

In place of the belt drive unit shown here, other gears can obviously be used as well, such as only a tooth gearing, or planet gears and suchlike.

Known wheel and disk gears may be used as well. In place of the ball screw mentioned here with ball tracks for multiple balls that cooperate with corresponding ball tracks in the spindle nut, trapeze spindles may also be used. Trapeze spindles of this type have a trapezoidal thread on their outer circumference, which is in combing engagement with a matching trapezoidal inside thread on the spindle nut.

For the spring actuator it is preferred if a helical pressure spring is used. A helical pressure spring of this type has proven useful because of its long displacement path. This is why a spring guide is present, which prevents the helical pressure spring from buckling. A preferred displacement path is, e.g., 75 mm. The spring then has a length of 260 mm in its pretensioned condition, but in the resting position of the drive.

In place of a spring actuator consisting of a helical pressure spring, other spring actuators may, of course, be used as well, e.g., tension springs, torsion springs, leg springs, gas pressure springs, and suchlike.

The advantage of the utilized helical pressure spring is that it directly encompasses the ball screw and rests at its one end with the spindle nut that is disposed on one side of the ball screw, whereas the other end is supported on a pillow block that is immovably connected to the housing. In this manner a relatively high spring force is generated along the shortest possible length and a very short housing length is also attained by placing the helical pressure spring directly onto the ball screw.

The force effect of the spring to close the door or hold it shut, can, of course, also be increased by switching on the electric motor.

The invention is not limited to the use of a single ball screw. Two ball screws that operate in parallel and are driven synchronously by a single motor may be utilized as well.

It is also possible to mirror-invert the assembly shown in the drawings in order, for example, to use the right drive assembly to drive the right door wing and the left drive assembly to drive the left door wing. This possibility too shall be covered by the invention.

The inventive object of the present invention results not only from the subject matter of the individual patent claims but also from combining the individual claims with one another.

All data and characteristics revealed in the documentation, including in the abstract, and in particular the three-dimensional embodiment presented in the drawings, are claimed as essential to the invention as far as they are novel compared to the prior art, either individually or in combination.

The invention will be explained in more detail below based on one possible execution. Additional characteristics and advantages that are essential for the invention will become apparent from these drawings and their description as follows:

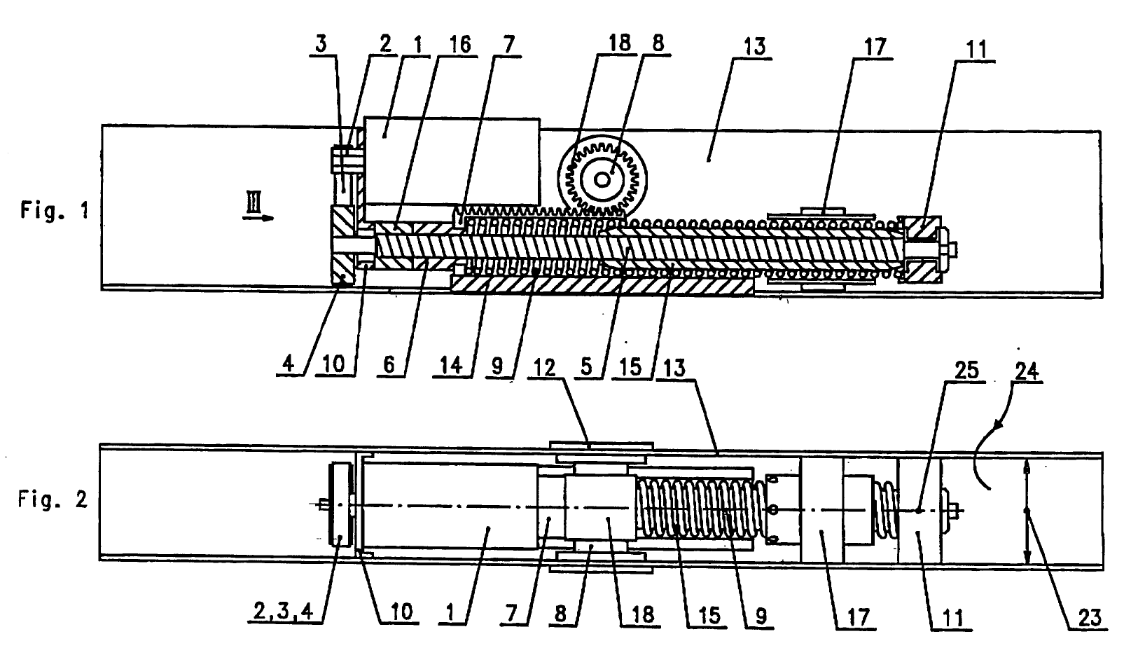

FIG. 1: shows a section through a double door drive unit according to the invention,

FIG. 2: shows a top view of the system according to FIG. 1,

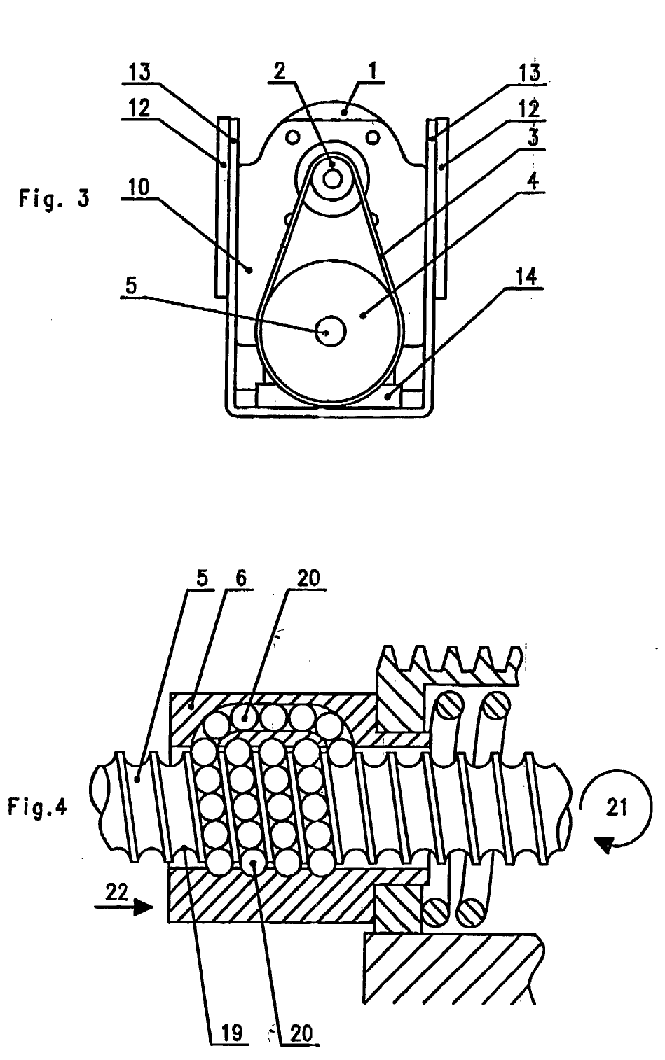

FIG. 3: shows a front view of the system according to FIG. 1 in the direction of the arrow III,

FIG. 4: shows a section through a ball screw nut and ball screw in a schematic presentation.

According to FIGS. 1 and 2, the double door drive unit consists of an approximately U-shaped housing element 13, with the legs of the “U” disposed parallel and at an equal distance from one another.

Into the housing section 13, which is open on the top, the entire drive unit is integrated. It essentially consists of an electric motor 1, the longitudinal axis of which extends parallel to the longitudinal axis of the entire housing profile 13.

The driven shaft of the electric motor 1 is connected to a motor pinion 2 to be integral in rotation therewith, over which a ribbed belt 3 extends, which, in turn is looped over a counter gear 4.

The counter gear 4 is connected to one end of a ball screw 5 to be integral in rotation therewith, the other opposite end of which is held rotating in a support flange 11 that is solidly connected to the housing.

On the ball screw 5 a spindle nut 6 is supported in a manner so that it can rotate. It, in turn, is solidly connected to a toothed rack 7, which is executed approximately U-shaped.

The base leg of the U-shaped toothed rack 7 can be seen in a section in FIG. 1. The side legs of the U-shaped toothed rack 7 extend past the ball screw 5 on the right and left and form anti-rotation end stops that cooperate with an assigned toothed-rack guide 14.

The toothed-rack guide 14 is a plastic part that is disposed on the inside of the base leg of the housing section 13 and forms the anti-rotation end stops for the side legs of the U-shaped toothed rack 7. The respective front face of the side leg of the toothed rack 7 rests on the surface of the toothed-rack guide 14. This results in the advantage that when the toothed rack 7 bends to a certain degree, the side legs come to rest on the toothed-rack guide 14, thus preventing the relatively long ball screw 5 from sagging. The latter is thus protected against sagging by the U-shaped toothed rack 7 and by the toothed-rack guide 14.

The base leg of the U-shaped toothed rack 7 is in combing engagement with a pinion 18, which is connected to a driven shaft 8 integral in rotation therewith. The driven shaft 8 is connected, integral in rotation therewith, to swivel arms that are not shown in detail.

A swivel arm rod system is thus provided, the swivelable part of which is connected to the driven shaft 8 to be integral in rotation therewith. This swivel arm rod system actuates the double door.

It is now important that the toothed rack 7 effects the tightening of a spring actuator. In the presented embodiment the spring actuator consists of a spring 9 which is executed as a helical pressure spring. Its one end is supported on a matching flange on the toothed rack 7, said flange being extended appropriately radially inward, whereas the other end rests on a support flange 11 that is solidly connected to the housing.

The spring 9 is installed in an already pretensioned condition in the position shown in FIG. 1, and therefore already has a spring pretension on the toothed rack 7 in this position.

The electric motor 1 is fastened in a motor flange 10 in the housing element 13. The rotational support for the ball screw 5 is housed in the area of this motor flange 10.

The driven shaft 8 with its pinion 18 is housed in a flange 12 in the housing element 13, and the ball bearing for the rotation bearing of the driven shaft 8 is disposed in the flange 12.

To protect against a buckling of the spring 9 a spring guide 15 is provided. It consists of a sleeve-shaped plastic part which encompasses the ball screw 5 on its outer circumference and which carries the spring 9 at least in part.

The spring is thus protected particularly against a buckling in the region behind the toothed-rack guide 14 and in front of the support flange 11.

Mechanical end stops are additionally provided, with an end stop 16 in the rear area characterizing the closed position of the double door drive, whereas an end stop 17 is present on the housing at a distance from the former, at which the toothed rack 7 then stops in the open position of the double door.

Electric shaft encoders or position sensors are, of course, also provided, which convert the given movement of the toothed rack 7 into corresponding electrical signals and communicate them to the control as a position signal.

If the ball screw 5 in FIG. 4, for example, accordingly rotates in the direction of the arrow 21, the spindle nut 6 is moved in the direction of the arrow 22.

In the process, the balls 20 recirculate in ball tracks 19 that are disposed diagonally to the direction of the arrow 22 on the outer circumference of the ball screw 5 and, in the process, engage into assigned matching ball tracks on the inner circumference of the spindle nut 6.

It is, therefore, of importance in the invention, that the height 23 is designed very small regarding the front view of the housing in FIG. 2. This front view is marked as 24 in FIG. 2.

It is also important that a relative short overall length is attained in the direction of the longitudinal axis 25.

Minimizing the height 23 is thus effected with the above-mentioned ball screw, which is combined as a preferred step-down member together with a spring actuator so that a double door drive unit with a spring actuator can be attained in the smallest possible space.

Drawing Legend

| | |
|---|---|
| 1 | Motor |
| 2 | Motor Pinion |
| 3 | Ribbed Belt |
| 4 | Counter Gear |
| 5 | Ball Screw |
| 6 | Spindle Nut |
| 7 | Toothed Rack |
| 8 | Driven Shaft |
| 9 | Spring |
| 10 | Motor Flange |
| 11 | Support Flange |
| 12 | Flange |
| 13 | Housing Element |
| 14 | Toothed-Rack Guide |
| 15 | Spring Guide |
| 16 | End Stop Closed |
| 17 | End Stop Open |
| 18 | Pinion |
| 19 | Ball Track |
| 20 | Ball |
| 21 | Direction of Rotation |
| 22 | Direction of Arrow |
| 23 | Height |
| 24 | Front Face |
| 25 | Longitudinal Axis |

What is claimed is:

1. A double door drive unit with spring closing system wherein the double door is opened by means of a drive unit and closed by spring force, characterized in that a toothed rack (7), which works against the load of a spring actuator (9) is guided axially movable on a rotating driven ball screw (5), and that the toothed rack (7) is in combing engagement with a pinion (18), which, in turn, is connected to the driving linkage for the double door drive.

2. A double door drive unit according to claim 1, characterized in that a freely moving ball screw (5) is utilized that is low-friction due to its design.

3. A double door drive unit according to claim 1 or 2, characterized in that to reduce the friction between the threaded spindle (5) and spindle nut (6), ball tracks are disposed, which are filled with matching balls (20).

4. A double door drive unit according to any of claims 1, 2, or 3, characterized in that the spindle nut (6) is connected to a toothed rack (7) so that the entire assembly of spindle nut (6) and toothed rack (7) is supported on the threaded spindle (5) such that it can be moved in the axial direction but not rotated.

5. A double door drive unit according to any of claims 1 through 4, characterized in that when the spindle nut (6) is displaced in one direction, the spring actuator (9) is charged accordingly.

6. A double door drive unit according to any of claims 1 through 5, characterized in that if the motor (1) is non-operational, the force of the spring (9) is sufficient when there is no electric power to the motor to move the spindle nut (6) back into its original starting position with a relaxed spring actuator.

7. A double door drive unit according to any of claims 1 through 6, characterized in that even when there is an electric power outage, it is possible to open the door by manually pushing on the double door, because the toothed rack (7) is then also moved via the torque on the pinion (18), and due to the lower friction of the spindle nut (6) on the ball screw (5) this ball screw (5) then rotates automatically, causing the spring actuator (9) to be recharged, even if there is no electric power to the drive.

8. A double door drive unit according to any of claims 1 through 7, characterized in that a rotating drive of the ball screw (5) also results from forces placed on the toothed rack (7) from the driven side.

9. A double door drive unit according to any of claims 1 through 8, characterized in that the force effect of the spring actuator is increased by the motor.

10. A double door drive unit according to any of claims 1 through 9, characterized in that a helical pressure spring is utilized as the spring actuator (9).

11. A double door drive unit according to any of claims 1 through 9, characterized in that the helical pressure spring directly encompasses the ball screw (5) and rests at its one end with the spindle nut (6) that is disposed on one side of the ball screw (5), whereas the other end rests on a support flange (11) that is solidly connected to the housing.

12. A double door drive unit according to any of claims 1 through 11, characterized in that two threaded spindles (5) are used that operate in parallel and are driven synchronously by a single motor (1).

13. A double door drive unit according to any of claims 1 through 12, characterized in that the assembly of the double door drive unit is executed mirror-inverted in order, for example, to drive the right door wing with the right drive assembly and the left door wing with the left drive assembly.

14. A double door drive unit according to any of claims 1 through 13, characterized in that the motor (1) of the drive unit is connected in its axial extension directly to the ball screw (5).

15. A double door drive unit according to any of claims 1 through 14, characterized in that the ball screw (5) is driven via the motor (1) and an appropriate gear.

16. A double door drive unit according to any of claims 1 through 15, characterized in that the motor (1) of the drive unit is disposed offset above or adjacent to the ball screw (5) and drives the same via a step-down gear.

17. A double door drive unit according to any of claims 15 or 16, characterized in that the gear is designed as a belt gear.

18. A double door drive unit according to any of claims 15 through 17, characterized in that the belt gear is connected to the driven shaft (8) of the motor to be integral in rotation therewith, and incorporates a motor pinion (2) on which a ribbed belt (3) is placed, which operates via a counter gear (4) with an enlarged diameter, which, in turn is connected to the ball screw (5) to be integral in rotation therewith.

19. A double door drive unit according to any of claims 1 through 18, characterized in that the spindle drive is executed as a trapeze spindle.
